(19) United States
(12) Patent Application Publication
(10) Pub. No.: US 2015/0310398 A1
(43) Pub. Date: Oct. 29, 2015

(54) GENERATION OF MEETING AGENDA FROM TEAM WORK PLAN

(71) Applicant: International Business Machines Corporation, Armonk, NY (US)

(72) Inventors: Philip S.P. Chan, Marrickville (AU); Laurence A. Hey, Manly (AU); William J. Izard, Leichhardt (AU); Matthew J. Ponsford, Manly (AU)

(73) Assignee: International Business Machines Corporation, Armonk, NY (US)

(21) Appl. No.: 14/264,656

(22) Filed: Apr. 29, 2014

(51) Int. Cl. G06Q 10/10

(52) U.S. Cl. CPC G06Q 10/1095

(57) ABSTRACT

A method for generating a meeting agenda associated with a calendar application and a team planning tool is provided. The method may include retrieving a plurality of work items associated with the team planning tool and the calendar application. The method may also include sorting the plurality of work items based on a pre-determined criteria. The method may further include determining at least one incomplete work item within the plurality of sorted work items. Additionally, the method may include creating a topic associated with the meeting agenda for the at least one incomplete work item. The method may include assigning a focal point for the created topic. The method may also include assigning a time limit for the created topic based on the sorting of the plurality of work items.

### FIELD OF THE INVENTION

The present invention relates generally to the field of computing, and more particularly to meeting agendas.

### BACKGROUND

A team planning tool is designed to help teams plan their work schedules. It allows users to create plans for periods of time and for teams. Work items may be given assigned priorities and work-effort estimates. Additionally, work items may be assigned to team members who can indicate items that are currently in progress as well as estimates associated with the progress. The same teams, or sub-sets of the teams, may typically organize meetings to discuss progress, and address issues with the on-going work.

### SUMMARY

According to one embodiment, a method for generating a meeting agenda associated with a calendar application and a team planning tool is provided. The method may include retrieving a plurality of work items associated with the team planning tool and the calendar application. The method may also include sorting the plurality of work items based on a pre-determined criteria. The method may further include determining at least one incomplete work item within the plurality of sorted work items. Additionally, the method may include creating a topic associated with the meeting agenda for the at least one incomplete work item. The method may include assigning a focal point for the created topic. The method may also include assigning a time limit for the created topic based on the sorting of the plurality of work items.

According to another embodiment, a computer system for generating a meeting agenda associated with a calendar application and a team planning tool is provided. The computer system may include one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method. The method may include retrieving a plurality of work items associated with the team planning tool and the calendar application. The method may also include sorting the plurality of work items based on a pre-determined criteria. The method may further include determining at least one incomplete work item within the plurality of sorted work items. Additionally, the method may include creating a topic associated with the meeting agenda for the at least one incomplete work item. The method may include assigning a focal point for the created topic. The method may also include assigning a time limit for the created topic based on the sorting of the plurality of work items.

According to yet another embodiment, a computer program product for generating a meeting agenda associated with a calendar application and a team planning tool is provided. The computer program product may include one or more computer-readable tangible storage medium and program instructions stored on at least one of the one or more tangible storage medium, the program instructions executable by a processor. The computer program product may include program instructions to retrieve a plurality of work items associated with the team planning tool and the calendar application. The computer program product may also include program instructions to sort the plurality of work items based on a pre-determined criteria. The computer program product may further include program instructions to determine at least one incomplete work item within the plurality of sorted work items. Additionally, the computer program product may include program instructions to create a topic associated with the meeting agenda for the at least one incomplete work item. The computer program product may include program instructions to assign a focal point for the created topic. The computer program product may also include program instructions to assign a time limit for the created topic based on the sorting of the plurality of work items.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to one embodiment;

FIG. 2 is an operational flowchart illustrating the steps carried out by a program to generate a meeting agenda according to at least one embodiment;

FIG. 3 is an operational flowchart illustrating an alternate implementation of the steps carried out by a program to generate a meeting agenda, according to at least one embodiment; and

FIG. 4 is a block diagram of internal and external components of computers and servers depicted in FIG. 1 according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

Embodiments of the present invention relate generally to the field of computing, and more particularly to meeting agendas. The following described exemplary embodiments provide a system, method and program product to, among other things, match a meeting invitation to a team or a team sub-set in a work-item based planning tool, and use the current plan's scheduled items, their progress, their sizing, and their priority, to dynamically generate and maintain a meeting agenda. Furthermore, the present embodiment may generate a list of highlights since the last meeting agenda. Additionally, meeting minutes made within the meeting agenda may be pushed back to the planning tool work items for tracking purposes.

As previously described, a team planning tool is designed to help teams plan their work schedules. The same teams, or sub-sets of the teams, may typically organize meetings to discuss progress, and address issues with the on-going work. These meetings may benefit from an agenda that has been organized and distributed prior to the meeting being held. Although there may be a strong conceptual link between the contents of the plan in the team planning tool and the meeting invitation in the calendar application, there may not be an actual link between the systems. As such, it may be advantageous, among other things, to implement a system which may match a meeting invitation associated with a calendar application to a team or a team's sub-set in a work-item based planning tool to dynamically generate and maintain a meeting agenda.

According to at least one embodiment, a link may be established between the plan or the team associated with a team planning tool and a meeting associated with a calendar application.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product to, among other things, establish a link between a plan or a team associated with a team planning tool and a meeting associated with a calendar application. According to at least one implementation, the present embodiment may explicitly define a link between a plan or a team associated with a team planning tool and a meeting associated with a calendar application when a meeting is scheduled. The method may include using a pointer or a uniform resource identifier (URI) of the plan or team in the application program interface (API) of the team planning tool.

According to another implementation, the link between a plan or a team associated with a team planning tool and a meeting associated with a calendar application may be determined dynamically by matching members of the invite list to a smallest team containing all the individuals on the invite list, or a fuzzy approximation of all the individuals on the invite list. If a clear match cannot be determined, then the individual sending the meeting invite may be presented with a list of teams to choose from, such as sorted by likelihood of a match.

Furthermore, according to another implementation, the link between a plan or a team associated with a team planning tool and a meeting associated with a calendar application may be determined using a fuzzy search within the planning tool based on the heading or description of the meeting. For example, “Core Product 4.0 status” may match the “Core Product” team in an application, such as IBM Rational Team Concert (RTC) and the “4.0” plan.

Additionally, according to yet another embodiment, the method may be implemented as a module within a larger system containing both the plan, the team, and the meeting. Such a method may include similar algorithms as previously described with respect to the implementations described above.

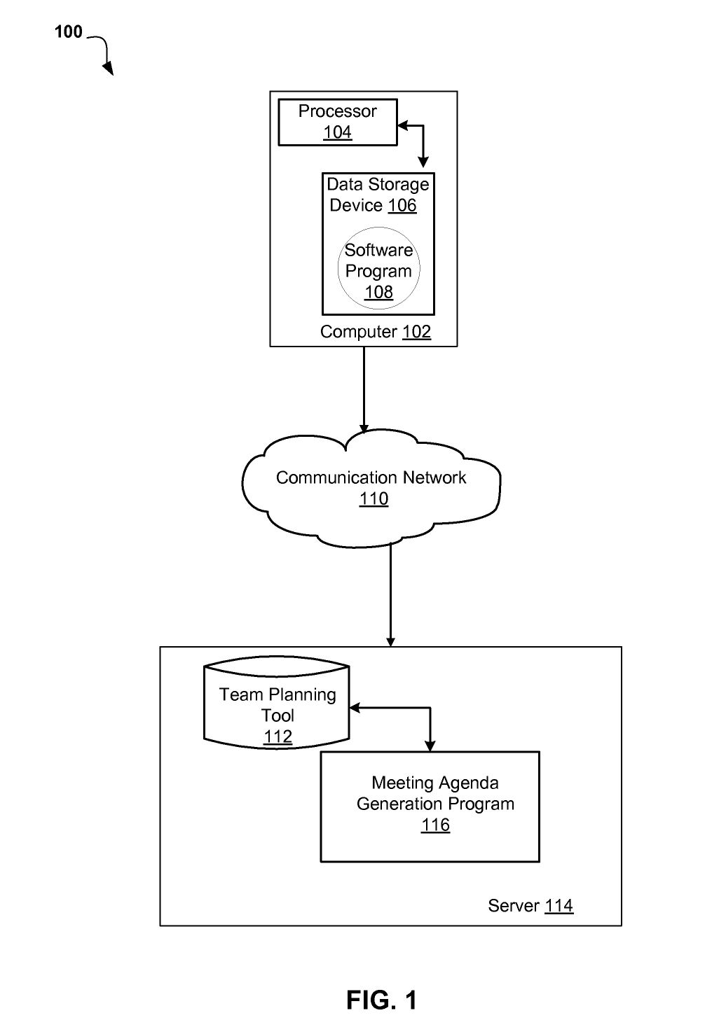

Referring now to FIG. 1, an exemplary networked computer environment 100 in accordance with one embodiment is depicted. The networked computer environment 100 may include a computer 102 with a processor 104 and a data storage device 106 that is enabled to run a software program 108, such as a calendar application. The networked computer environment 100 may also include a team planning tool 112, such as IBM Rational Team Concert (RTC), a server 114 running a Meeting agenda generation program 116 and a communication network 110. The networked computer environment 100 may include a plurality of computers 102 and servers 114, only one of which is shown. The communication network may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

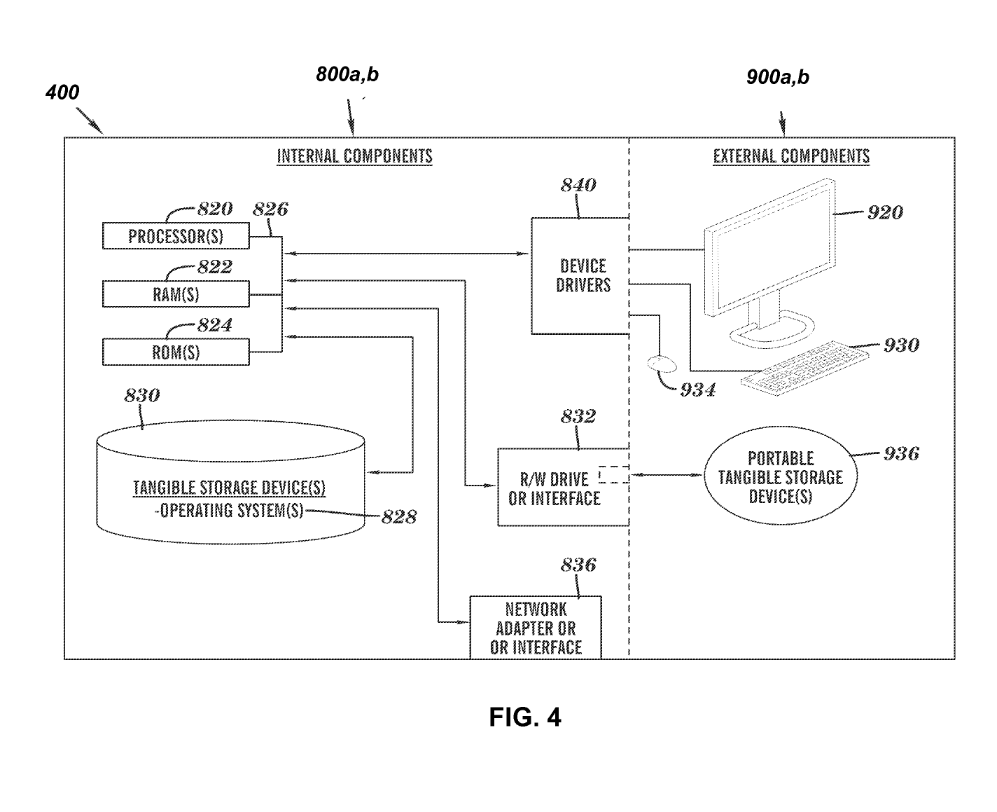

The client computer 102 may communicate with the team planning tool 112 running on server computer 114 via the communications network 110. The communications network 110 may include connections, such as wire, wireless communication links, or fiber optic cables. As will be discussed with reference to FIG. 4, server computer 114 may include internal components 800a and external components 900a, respectively, and client computer 102 may include internal components 800b and external components 900b, respectively. Client computer 102 may be, for example, a mobile device, a telephone, a personal digital assistant, a netbook, a laptop computer, a tablet computer, a desktop computer, or any type of computing devices capable of accessing a network.

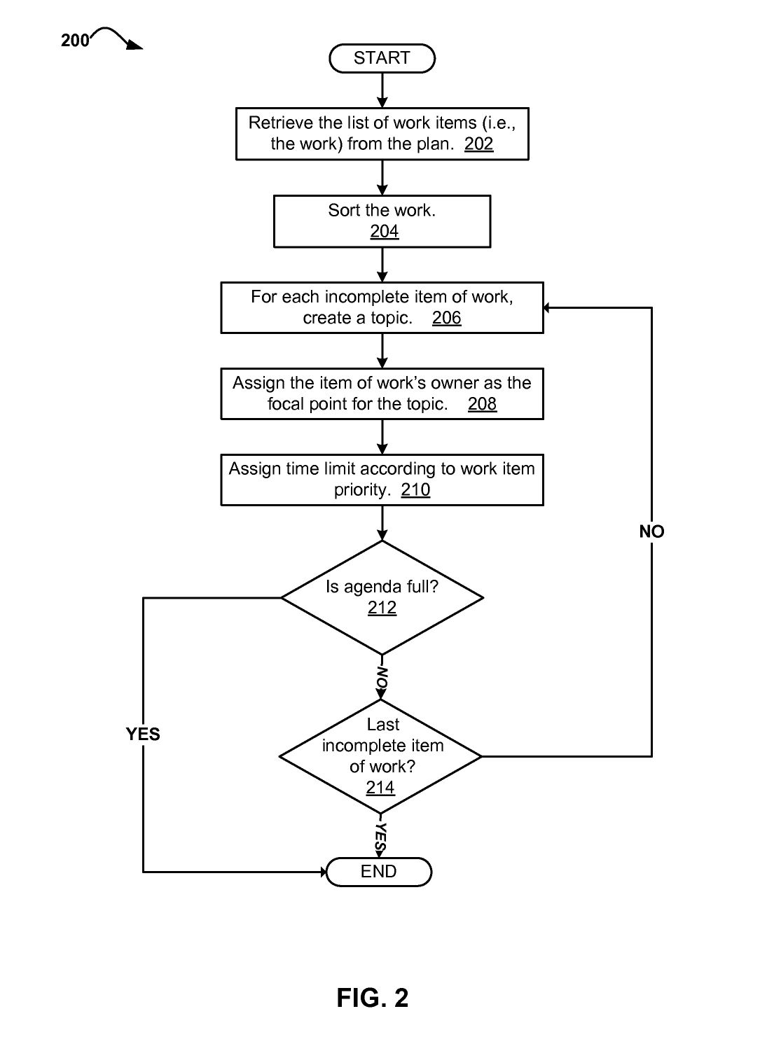

As previously described, the client computer 102 may access the team planning tool 112, running on server computer 114 via the communications network 110. For example, a user using an application program 108 (e.g., Firefox®) (Firefox and all Firefox—based trademarks and logos are trademarks or registered trademarks of Mozilla and/or its affiliates) running on a client computer 102 may connect via a communication network 110 to the team planning tool 112 which may be running on server computer 114. The Meeting agenda generation program 116, running on server computer 114 may establish a link between the plan or team in the team planning tool 112 and a calendar application. The Meeting agenda generation program 116 may generate an agenda consisting of a list of topics to discuss. According to one implementation, the Meeting agenda generation program 116 may use a meeting invite list of attendees generated from a calendar application in conjunction with the plan generated from the team planning tool 112 to generate an agenda for the meeting. The method associated with the Meeting agenda generation program 116 is explained in further detail below with respect to FIG. 2.

FIG. 2, an operational flowchart 200 illustrating the steps carried out by a program to generate a meeting agenda is depicted. As previously described, the Meeting agenda generation program 116 (FIG. 1) running on server 114 (FIG. 1) may generate a meeting agenda associated with a calendar application and a team planning tool 112 (FIG. 1). The meeting agenda may consist of a list of topics to discuss. Each topic may concern one or more work items associated with a plan. Also, each topic may have a team member around whom the discussion may focus. Additionally, a total run time may be associated with the agenda. The total run time may be based on the length of the scheduled meeting. Furthermore, each topic may be assigned a suggested discussion time based on the total available meeting time, and the priority and sizing of the concerned work items. Additionally, the topics may be sorted by priority in the agenda. The Meeting agenda generation program 116 (FIG. 1) may generate an agenda for the meeting based on the meeting invite list (i.e., the attendees) as contained in a calendar application and the plan associated with the team planning tool 112 (FIG. 1).

At 202, the list of work items (i.e., the work) is retrieved from the plan. Work items are the fundamental mechanism to track and coordinate development tasks and workflows and they provide the hub for linkage between the various artifacts associated with the team planning tool 112 (FIG. 1). As such, the Meeting agenda generation program 116 (FIG. 1) may retrieve the list of work items (i.e., the work) from the team planning tool 112 (FIG. 1). According to one implementation of the present embodiment, the retrieved list may be filtered by the attendees associated with a meeting invite list corresponding to a calendar application.

Then at 204, the work is sorted. Therefore, the work items may be sorted (in order) based upon a pre-determined criteria, such as completion status, priority, and sizing. For example, according to one implementation, a list of work items may be generated that lists the largest, incomplete, or high priority work items at the top of the list.

Next at 206, a topic is created for each incomplete item of work. For example, a topic of discussion (e.g., a status of the work item) may be created for each incomplete item of work. As such, the Meeting agenda generation program 116 (FIG. 1) may determine at least one incomplete work item within a plurality of sorted work items and create a topic for the at least one incomplete work item.

Then at 208, the item of work's owner is assigned as the focal point for the created topic. For example, the Meeting agenda generation program 116 (FIG. 1) may retrieve the owners associated with the list of work items (i.e., the work) from the team planning tool 112 (FIG. 1) and assign the work's owner as the focal point for the topic.

Next 210, a time limit may be assigned to the created topic according to the work item priority. As such, a time limit may be assigned for the created topic based upon the previous sorting. For example, a high priority work item may be assigned 15 minutes of time on the meeting agenda, while a low priority item may be assigned 5 minutes of time on the meeting agenda.

Then at 212, it is determined whether the meeting agenda is full. If at 212, it is determined that the meeting agenda is full, then the method may end. However, if at 212, it is determined that the meeting agenda is not full, then the method may continue to 214 and determine whether the work item is the last incomplete item of work. If at 214, it is determined that the work item is not the last incomplete item of work, then the method may continue back to step 206 and finish creating a topic for each incomplete item of work. However, if at 214, it is determined that the work item is the last incomplete item of work, then the method may end.

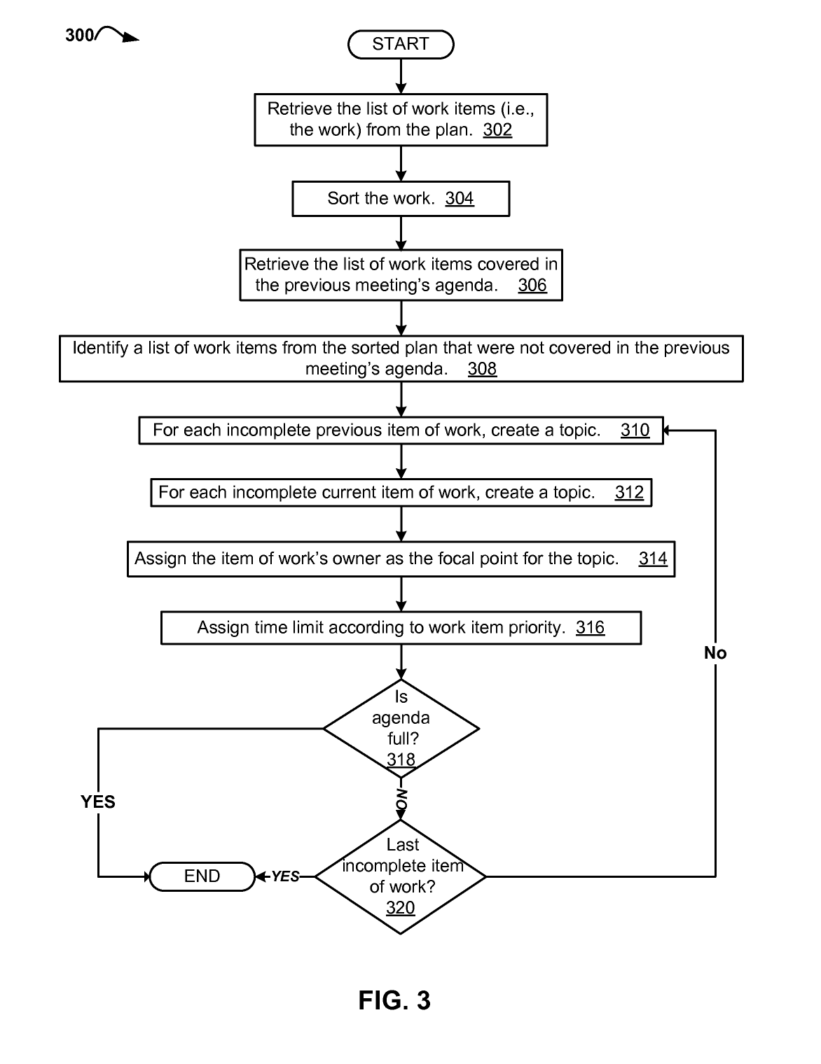

FIG. 3, an operational flowchart 300 illustrating an alternate implementation of the steps carried out by a program to generate a meeting agenda is depicted. According to one implementation of the present embodiment, priority may be given to those items not covered in the previous meeting.

As such, at 302, the list of work items (i.e., the work) is retrieved from the plan. As such, the Meeting agenda generation program 116 (FIG. 1) may retrieve the list of work items (i.e., the work) from the team planning tool 112 (FIG. 1). According to one implementation of the present embodiment, the retrieved list may be filtered by the attendees associated with the meeting invite list.

Then at 304, the work is sorted. Therefore, the work items may be sorted (in order) based upon a pre-determined criteria, such as completion status, priority, and sizing. For example, according to one implementation, a list of work items may be generated that lists the largest, incomplete, or high priority work items at the top of the list.

Next at 306, the list of work items covered in the previous meeting's agenda are retrieved. As such, the Meeting agenda generation program 116 (FIG. 1) may retrieve the list of work items (i.e., the work) that was covered in the previous meeting's agenda from the team planning tool 112 (FIG. 1).

Then at 308, the work items from the previously sorted plan that were not covered in the previous meeting's agenda are identified. For example, the Meeting agenda generation program 116 (FIG. 1) may identify the work items that were not covered in the previous meeting's agenda so that priority may be given to the previous work items before the current work items.

Next 310, a topic is created for each incomplete previous item of work. For example, a topic of discussion (e.g., a status of the work item) may be created for each incomplete previous item of work. Then at 312, a topic is created for each incomplete current item of work. For example, a topic of discussion (e.g., a status of the work item) may be created for each incomplete current item of work.

Next at 314, the item of work's owner is assigned as the focal point for the topic. For example, the Meeting agenda generation program 116 (FIG. 1) may retrieve the owners associated with the list of work items (i.e., the previous incomplete work items and the current incomplete work items) from the team planning tool 112 (FIG. 1) and assign the work's owner as the focal point for the topic associated with the work item.

Then at 316, a time limit may be assigned to the created topic according to the work item priority. As such, a time limit may be assigned for the created topic based upon the previous sorting. For example, a high priority work item may be assigned 15 minutes of time on the meeting agenda, while a low priority item may be assigned 5 minutes of time on the meeting agenda.

Next at 318, it is determined whether the meeting agenda is full. If at 318, it is determined that the meeting agenda is full, then the method may end. However, if at 318, it is determined that the meeting agenda is not full, then the method may continue to 320 and determine whether the work item is the last incomplete item of work. If at 320, it is determined that the work item is not the last incomplete item of work, then the method may continue back to step 310 and finish creating a topic for each previous incomplete item of work. However, if at 320, it is determined that the work item is the last incomplete item of work, then the method may end.

It may be appreciated that FIGS. 2-3 provide only an illustration of two implementations of the present embodiment and do not imply any limitations with regard to how different embodiments may be implemented. Many modifications to the depicted environments may be made based on design and implementation requirements. As such, in an alternate implementation of the present embodiment the Meeting agenda generation program 116 (FIG. 1) may generate a list of highlights for a meeting. Therefore, the Meeting agenda generation program 116 (FIG. 1) may generate a highlight based on a significant change to one of the work items from the plan. For example, a highlight may be that a work item was completed; a work item has been marked as blocked; if dependencies have been introduced between work items; or if new work items have been added.

Furthermore, according to at least one implementation of the present embodiment, the agenda topics may be presented to the user as a form, with editable fields to contain meeting minutes for each topic. Then at the end of the meeting, as a topic is associated with a work item in the plan, the Meeting agenda generation program 116 (FIG. 1) may append the topic's minutes back into the team planning tool 112 (FIG. 1) work item, for tracking purposes. Furthermore, the agenda may be dynamically updated as the meeting approaches and the plan is updated. For example, according to one implementation, the agenda may be updated on a schedule, such as on the hour. Additionally, according to another implementation, the agenda may be updated each time the plan is updated, via a callback between the team planning tool and the Meeting agenda generation program 116 (FIG. 1).

FIG. 4 is a block diagram 400 of internal and external components of computers depicted in FIG. 1 in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 (FIG. 1), and network server 114 (FIG. 1) may include respective sets of internal components 800a, b and external components 900a, b illustrated in FIG. 4. Each of the sets of internal components 800a, b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and software program 108 (FIG. 1) in client computer 102 is stored on one or more of the respective computer-readable tangible storage medium 830 for execution by one or more of the respective processors 820 via one or more of the respective RAMs 822 (which typically include cache memory). In the embodiment illustrated in FIG. 4, each of the computer-readable tangible storage medium 830 is a magnetic disk storage device of an internal hard drive. Alternatively, each of the computer-readable tangible storage medium 830 is a semiconductor storage device such as ROM 824, EPROM, flash memory or any other computer-readable tangible storage device that can store a computer program and digital information.

Each set of internal components 800a, b also includes a R/W drive or interface 832 to read from and write to one or more portable computer-readable tangible storage medium 936 such as a CD-ROM, DVD, memory stick, magnetic tape, magnetic disk, optical disk or semiconductor storage device. A software program 108, such as Meeting agenda generation program 116, can be stored on one or more of the respective portable computer-readable tangible storage medium 936, read via the respective R/W drive or interface 832 and loaded into the respective hard drive 830.

Each set of internal components 800a, b also includes network adapters or interfaces 836 such as a TCP/IP adapter cards, wireless Wi-Fi interface cards, or 3G or 4G wireless interface cards or other wired or wireless communication links. The software program 108 in client computer 102 and Meeting agenda generation program 116 can be downloaded to client computer 102 and server computer 114, respectively from an external computer via a network (for example, the Internet, a local area network or other, wide area network) and respective network adapters or interfaces 836. From the network adapters or interfaces 836, the code software program 108 in client computer 102 and Meeting agenda generation program 116 in server computer 114 are loaded into the respective hard drive 830. The network may comprise copper wires, optical fibers, wireless transmission, routers, firewalls, switches, gateway computers and/or edge servers.

Each of the sets of external components 900a, b can include a computer display monitor 920, a keyboard 930, and a computer mouse 934. External components 900a, b can also include touch screens, virtual keyboards, touch pads, pointing devices, and other human interface devices. Each of the sets of internal components 800a, b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1.-7. (canceled)

8. A computer system for generating a meeting agenda associated with a calendar application and a team planning tool, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
retrieving a plurality of work items associated with the team planning tool and the calendar application;
sorting the plurality of work items based on a pre-determined criteria;
determining at least one incomplete work item within the plurality of sorted work items;
creating a topic associated with the meeting agenda for the at least one incomplete work item;
assigning a focal point for the created topic; and
assigning a time limit for the created topic based on the sorting of the plurality of work items.

9. The computer system of claim 8, wherein the pre-determined criteria comprises at least one of a completed status; a priority; and a sizing.

10. The computer system of claim 8, wherein the sorting comprises generating a list of the work items in order based on at least one of the largest work items; the incomplete work items; and the priority work items being placed first on the generated list.

11. The computer system of claim 8, wherein the assigning a focal point comprises assigning an owner associated with the work item as the focal point.

12. The computer system of claim 11, wherein the assigning the owner comprises retrieving an owner name associated with the work item from the team planning tool.

13. The computer system of claim 8, wherein retrieving a plurality of work items comprises filtering the plurality of work items based on attendees associated with a meeting invitation list corresponding to the calendar application.

14. The computer system of claim 8, wherein retrieving a plurality of work items comprises at least one of retrieving a list of current work items and retrieving a list of work items associated with a previous meeting's agenda.

15. A computer program product for generating a meeting agenda associated with a calendar application and a team planning tool, the computer program product comprising:
one or more computer-readable tangible storage medium and program instructions stored on at least one of the one or more tangible storage medium, the program instructions executable by a processor, the program instructions comprising:
program instructions to retrieve a plurality of work items associated with the team planning tool and the calendar application;
program instructions to sort the plurality of work items based on a pre-determined criteria;
program instructions to determine at least one incomplete work item within the plurality of sorted work items;
program instructions to create a topic associated with the meeting agenda for the at least one incomplete work item;
program instructions to assign a focal point for the created topic; and
program instructions to assign a time limit for the created topic based on the sorting of the plurality of work items.

16. The computer program product of claim 15, wherein the pre-determined criteria comprises at least one of a completed status; a priority; and a sizing.

17. The computer program product of claim 15, wherein the sorting comprises generating a list of the work items in order based on at least one of the largest work items; the incomplete work items; and the priority work items being placed first on the generated list.

18. The computer program product of claim 15, wherein the assigning a focal point comprises assigning an owner associated with the work item as the focal point.

19. The computer program product of claim 18, wherein the assigning the owner comprises retrieving an owner name associated with the work item from the team planning tool.

20. The computer program product of claim 15, wherein retrieving a plurality of work items comprises filtering the plurality of work items based on attendees associated with a meeting invitation list corresponding to the calendar application.
